(19) United States
(12) Patent Application Publication
(10) Pub. No.: US 2009/0195969 A1
(43) Pub. Date: Aug. 6, 2009

(54) SOLID ELECTROLYTIC CAPACITOR WITH LOW ESL AND SIMPLE STRUCTURE

(75) Inventors: Yuji YOSHIDA, Sendai-shi (JP); Takashi Mizukoshi, Sendai-shi (JP); Koji Sakata, Sendai-shi (JP); Katsuhiro Yoshida, Sendai-shi (JP); Takeshi Saito, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN CORPORATION, Sendai-shi (JP)

(21) Appl. No.: 12/365,235

(22) Filed: Feb. 4, 2009

(30) Foreign Application Priority Data
Feb. 4, 2008 (JP) 2008-024068

(51) Int. Cl. H01G 9/15

(52) U.S. Cl. 361/528

(57) ABSTRACT

The terminal plate 30 is attached to the capacitor elements 10 so that a second plate surface of the insulating plate 32 faces a side surface of each of the capacitor elements 10. The side surface is parallel to the longitudinal direction L1 and the thickness direction t1 of the anode plate 1.

This application is based upon and claims the benefit of priority from Japanese patent application No. 2008-024068, filed on Feb. 4, 2008, the disclosure of which is incorporated herein in its entirety by reference.

### BACKGROUND OF THE INVENTION

The present invention relates to a solid electrolytic capacitor including a capacitor element having: an anode plate made of valve action metal; a dielectric layer made of an oxide film of valve action metal; and a cathode layer including a solid electrolyte layer made of electroconductive polymer, and particularly, the present invention relates to a laminated type of solid electrolytic capacitor including a plurality of laminated capacitor elements and a terminal plate attached to the plurality of capacitor elements.

With miniaturization and high-functioning of electronic apparatuses in recent years, multi pins, speed up and high-speed transmission of a semiconductor device constituting the electronic apparatus advance. In order to cause these semiconductor devices to operate normally, passive components are mounted on a printed board on which semiconductor devices such as a processor are mounted.

Most of these passive components are capacitors. A first role of them is a role to smooth noise such as switching noise superimposed in supply voltage. A second role thereof is a role of a decoupling capacitor to prevent high-frequency noise generated in a processor to flow out to the overall printed board. A third role thereof is a role to prevent voltage drop to occur by switching operation modes of the processor and thereby supplying large current thereto in a short time.

In order to fulfill these roles of the capacitor effectively, a capacitor is required to have a small size, large capacitance, and low impedance over a wide frequency domain. Here, impedance of a capacitor mainly depends on capacitance and ESR (Equivalent Series Resistance) in a lower frequency domain rather than a self resonant point, but it mainly depends on ESL (Equivalent Series Inductance) in a higher frequency domain rather than the self resonant point.

In a solid electrolytic capacitor having a cathode layer including a solid electrolyte layer made of electroconductive polymer, a specific resistance value of the solid electrolyte layer is in the range of one tenth to one hundredth of other kind of solid electrolyte such as manganese dioxide or liquid electrolyte. For this reason, ESR of the solid electrolyte layer is low. Therefore, impedance in the low frequency domain is sufficiently low. However, it is an actual condition that in this laminated type of conventional solid electrolytic capacitor, ESL becomes large due to a wiring length from anode and cathode layers to an anode terminal and a cathode terminal and a wiring structure. For this reason, it could be hardly said that impedance in the high frequency domain is sufficiently low.

As measure to reduce the ESL, it is adopted a solid electrolytic capacitor including a plurality of anode terminals connected to an anode plate of the capacitor and a plurality of cathode terminals connected to a cathode layer. Such a structure causes the number of current loops generated between an anode terminal and a cathode terminal to become large, whereby ESL is to be reduced. Moreover, it is also adopted a structure in which a plurality of anode terminals and a plurality of cathode terminals are arranged alternately. Such a structure causes opposite direction current to flow between adjacent current paths when the capacitor is charged and discharged, a magnetic field generated due to the current to be canceled, and ESL to be reduced. The solid electrolytic capacitor in which a plurality of anode terminals and a plurality of cathode terminals are alternately arranged in this manner is disclosed in Japanese Patent Application Publication No. 2002-237431 (Patent Document 1), International Patent Application Publication WO2003/107366 (Patent Document 2), and Japanese Patent Application Publication No. 2006-344936 (Patent Document 3), for example.

Further, the applicant of the present application proposed a solid electrolytic capacitor including a plurality of laminated capacitor elements and a terminal plate attached to the plurality of capacitor elements (Japanese Patent Application Publication No. 2008-305825). This terminal plate includes a plurality of anode terminals respectively connected in common to anode plates of the plurality of capacitor elements, and a plurality of cathode terminals formed so as to be arranged alternately with the anode terminals and respectively connected in common to cathode layers of the capacitor elements. This solid electrolytic capacitor can achieve low ESL, and it has larger capacity compared with ones disclosed in Patent Documents 1 to 3. in addition, a structure of the capacitor (capacitor element) and a wiring structure to anode terminals and cathode terminals are simple.

FIGS. 1A to 1C show a solid electrolytic capacitor similar to one proposed in Japanese Patent Application No. 2007-148954. Referring to FIGS. 1A to 1C, this solid electrolytic capacitor includes a plurality of laminated capacitor elements 10 and a terminal plate 80 attached to the plurality of capacitor elements 10. As shown in FIG. 2, each capacitor element 10 has: an anode plate 1 made of valve action metal; a dielectric layer 2 made of an oxide film of valve action metal; and a cathode layer 3 formed on the dielectric layer 2. The anode plate 1 has a longitudinal direction L1, and is provided with an anode lead portion 1a at one end of the longitudinal direction. The dielectric layer 2 is formed on the anode plate 1 except for the anode lead portion 1a. The cathode layer 3 includes a solid electrolyte layer 3a made of electroconductive polymer. The plurality of capacitor elements 10 are laminated along a thickness direction t1 of the anode plate 1. The terminal plate 80 includes an insulating plate 82, a plurality of anode terminals 81 and a plurality of cathode terminals 83. The plurality of anode terminals 81 are formed on a first plate surface of the insulating plate 82, and are respectively connected in common to the anode lead portions 1a of the capacitor elements 10. The plurality of cathode terminals 83 are formed on the first plate surface of the insulating plate 82 so as to be arranged alternately with the anode terminals 81, and are respectively connected in common to the cathode layers 3 of the capacitor elements 10.

The solid electrolytic capacitor proposed in Japanese Patent Application Publication No. 2008-305825 can achieve low ESL, but a solid electrolytic capacitor in which ESL is further reduced is desired.

### SUMMARY OF THE INVENTION

It is therefore an object of the present invention to provide a solid electrolytic capacitor with large capacity, low ESL and a simple structure.

According to this invention, there is provided a solid electrolytic capacitor comprising a plurality of capacitor elements laminated to one another and a terminal plate attached to the plurality of capacitor elements; wherein each of the plurality of capacitor elements includes an anode plate, a dielectric layer, and a cathode layer, the anode plate being made of valve action metal and having a longitudinal direction, the anode plate being provided with an anode lead portion at one end of the longitudinal direction, the dielectric layer being made of an oxide film of valve action metal, the dielectric layer being formed on the anode plate except for the anode lead portion, the cathode layer including a solid electrolyte layer made of electroconductive polymer, the cathode layer being formed on the dielectric layer; wherein the plurality of capacitor elements are further laminated along a thickness direction of the anode plate; wherein the terminal plate includes an insulating plate, a plurality of anode terminals, and a plurality of cathode terminals, the plurality of anode terminals being formed on a first plate surface of the insulating plate, the plurality of anode terminals being respectively connected in common to the anode lead portions of the capacitor elements, the plurality of cathode terminals being formed on the first plate surface of the insulating plate so as to be arranged alternately with the anode terminals, the plurality of cathode terminals being respectively connected in common to the cathode layers of the capacitor elements; and wherein the terminal plate is further attached to the capacitor elements so that a second plate surface of the insulating plate faces a side surface of each of the capacitor elements, the side surface being parallel to the longitudinal direction and the thickness direction of the anode plate.

According to this invention, there is further provided an electronic apparatus comprising the solid electrolytic capacitor and a semiconductor device electrically connected to the solid electrolytic capacitor.

### BRIEF DESCRIPTION OF THE DRAWING

FIG. 1A is a plan view showing a conventional solid electrolytic capacitor as a comparative embodiment;

FIG. 1B is a sectional view taken along the section line 1B-1B in FIG. 1A;

FIG. 1C is a sectional view taken along the section line 1C-1C in FIG. 1B;

FIG. 2 is a sectional view showing a capacitor element used for a solid electrolytic capacitor;

FIG. 3A is a plan view showing a solid electrolytic capacitor according to a first embodiment of the present invention;

FIG. 3B is a sectional view taken along the section line 3B-3B in FIG. 3A;

FIG. 3C is a sectional view taken along the section line 3C-3C in FIG. 3B;

FIG. 3D is a sectional view taken along the section line 3D-3D in FIG. 3B;

FIG. 3E is a sectional view taken along the section line 3E-3E in FIG. 3B;

FIG. 4 is a perspective view showing a capacitor element and an anode lead plate used for the solid electrolytic capacitor according to the first embodiment;

FIG. 5A is a plan view showing a solid electrolytic capacitor according to a second embodiment of the present invention;

FIG. 5B is a sectional view taken along the section line 5B-5B in FIG. 5A;

FIG. 5C is a sectional view taken along the section line 5C-5C in FIG. 5B;

FIG. 5D is a sectional view taken along the section line 5D-5D in FIG. 5B;

FIG. 5E is a sectional view taken along the section line 5E-5E in FIG. 5B;

FIG. 6 is a perspective view showing a capacitor element and an anode lead plate used for the solid electrolytic capacitor according to the second embodiment of the present invention;

FIG. 7A is a plan view showing a solid electrolytic capacitor according to a third embodiment of the present invention;

FIG. 7B is a sectional view taken along the section line 7B-7B in FIG. 7A;

FIG. 7C is a sectional view taken along the section line 7C-7C in FIG. 7B;

FIG. 7D is a sectional view taken along the section line 7D-7D in FIG. 7B; and

FIG. 7E is a sectional view taken along the section line 7E-7E in FIG. 7B.

### DESCRIPTION OF THE EXEMPLARY EMBODIMENTS

A solid electrolytic capacitor according to the present invention includes a plurality of laminated capacitor elements and a terminal plate attached to the plurality of capacitor elements.

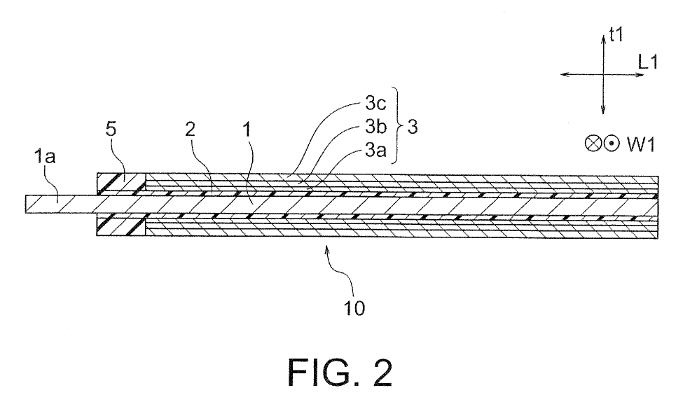

As shown in FIG. 2, each capacitor element 10 includes an anode plate 1, a dielectric layer 2 and a cathode layer 3.

The anode plate 1 is made of valve action metal, and has a longitudinal direction L1. The anode plate 1 includes an anode lead portion 1a at one end of the longitudinal direction L1.

The dielectric layer 2 is made of an oxide film of valve action metal, and is formed on the anode plate 1 except for the anode lead portion 1a.

The cathode layer 3 is formed on the dielectric layer 2, and includes a solid electrolyte layer 3a made of electroconductive polymer.

Namely, in this solid electrolytic capacitor, it is possible to utilize a capacitor element with the same simple structure as that of conventional one.

The plurality of capacitor elements 10 are laminated along a thickness direction t1 of the anode plate 1.

The terminal plate includes an insulating plate, a plurality of anode terminals and a plurality of cathode terminals.

The plurality of anode terminals are formed on a first plate surface of the insulating plate, and are respectively connected in common to the anode lead portions 1a of the capacitor elements 10.

The plurality of cathode terminals are formed on the first plate surface of the insulating plate so as to be arranged alternately with the anode terminals, and are respectively connected in common to the cathode layers 3 of the capacitor elements 10.

In this solid electrolytic capacitor, particularly, the terminal plate is attached to the capacitor elements 10 so that a second plate surface of the insulating plate faces a side surface of each of the capacitor elements 10 parallel to the longitudinal direction L1 and the thickness direction t1 of the anode plate 1.

Because of the above configuration, the solid electrolytic capacitor according to the present invention has large capacity, low ESL and a simple structure.

Further, the solid electrolytic capacitor according to the present invention can be configured using capacitor elements with a conventional structure as it is.

Further, an area required to mount the solid electrolytic capacitor according to the present invention may be made smaller compared with one in which the similar capacity to this is exerted, but capacitor elements are laminated horizontally.

Hereinafter, embodiments of the solid electrolytic capacitor according to the present invention will be described with reference to the drawings.

### First Embodiment

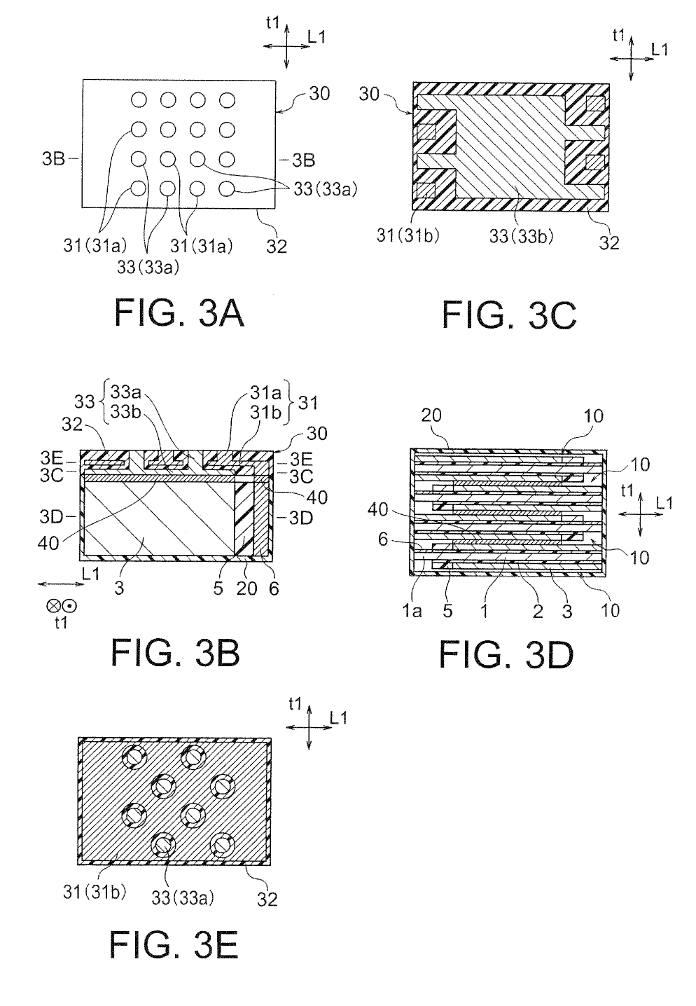

Referring to FIGS. 3A to 3E, a solid electrolytic capacitor according to a first embodiment of the present invention includes a plurality of laminated capacitor elements 10 and a terminal plate 30 attached to the plurality of capacitor elements 10.

Each capacitor element 10 includes an anode plate 1, a dielectric layer 2 and a cathode layer 3, as shown in FIG. 2.

The anode plate 1 is foil made of aluminum as valve action metal, and having a longitudinal direction L1. A surface of the anode plate 1 is made porous by means of etching. The anode plate 1 is provided with an anode lead portion 1a at one end in the longitudinal direction L1. A reference numeral 5 in the figures indicates an insulator existing on a border between the anode lead portion 1a of the anode plate 1 and the others.

The dielectric layer 2 is made of an oxide film of aluminum as valve action metal, and is formed on the anode plate 1 except for the anode lead portion 1a.

The cathode layer 3 is formed on the dielectric layer 2, and includes a solid electrolyte layer 3a made of electroconductive polymer, a graphite layer 3b and a metallic layer 3c.

Namely, in this solid electrolytic capacitor, it is possible to utilize a capacitor element with the same simple structure as that of conventional one.

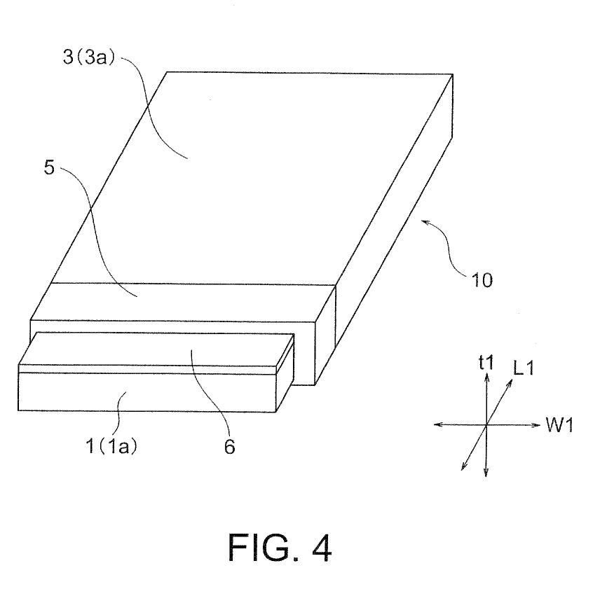

An anode lead plate 6 is connected to one plate surface of the anode lead portion 1a of each capacitor element 10 by means of welding or the like, as shown in FIG. 4.

The four sheets of capacitor elements 10 to each of which the anode lead plate 6 is connected are then laminated along the thickness direction t1 of the anode plate 1, as shown in FIG. 3D. The cathode layers 3 of the adjacent capacitor elements 10 are bonded by means of conductive adhesive 40. Further, the adjacent laminated capacitor elements 10 are arranged so that the anode lead portions 1a are opposed to each other.

The terminal plate 30 includes an insulating plate 32, a plurality of anode terminals 31 and a plurality of cathode terminals 33.

The plurality of anode terminals 31 include a plurality of anode terminal portions 31a and a single anode wiring portion 31b connected to these. As shown in FIG. 3A, the plurality of anode terminal portions 31a are formed on a first plate surface of the insulating plate 32 so as to be arranged in a matrix manner. Moreover, the plurality of anode terminal portions 31a are respectively connected in common to the anode lead portions 1a of the capacitor elements 10 via the anode wiring portions 31b, as shown in FIG. 3B.

In this regard, as is clear from FIG. 3E, the anode wiring portion 31b presents substantially a tabular shape.

As is clear from FIGS. 3A, 3B and 3E, eight anode terminal portions 31a are formed on a first plate surface of the anode wiring portion 31b. Eight slots are also dug in the first plate surface alternately with the eight anode terminal portions 31a and in correspondence to cathode terminal portions 33a of the cathode terminals 33 (will be described later).

On the other hand, as is clear from FIGS. 3A, 3B, 3C and 3D, four projections are formed on a second plate surface of the anode wiring portion 31b in correspondence to the anode lead portions 1a of the four capacitor elements 10. These projections are exposed onto a second plate surface of the insulating plate 32 (FIGS. 3B and 3C), and function as terminals to be bonded to the anode lead portions 1a.

The plurality of cathode terminals 33 include the plurality of cathode terminal portions 33a and a single cathode wiring portion 33b connected to these. The plurality of cathode terminal portions 33a are formed on the first plate surface of the insulating plate 32 so as to be arranged alternately with the anode terminals 31, as shown in FIG. 3A. Moreover, the plurality of cathode terminal portions 33a are respectively connected in common to the cathode layers 3 of the capacitor elements 10 via the cathode wiring portion 33b, as shown in FIG. 3B.

In this regard, as is clear from FIGS. 3B and 3C, the cathode wiring portion 33b presents a tabular shape.

As is clear from FIGS. 3A and 3B, eight cathode terminal portions 33a are formed on a first plate surface of the cathode wiring portion 33b in correspondence to the eight slots of the anode wiring portion 31b shown in FIG. 3E. Further, as is clear from FIGS. 3B and 3C, the cathode wiring portion 33b presents a planar shape in correspondence to the cathode layers 3 of the four capacitor elements 10.

A second plate surface of the cathode wiring portion 33b is exposed onto the second plate surface of the insulating plate 32, and functions as a terminal to be bonded to the cathode layers 3.

In this solid electrolytic capacitor, the terminal plate 30 is attached to the capacitor elements 10 so as to face a side surface of each capacitor element 10 parallel to the longitudinal direction L1 and the thickness direction t1 of the anode plate 1.

The anode wiring portion 31b exposed from the second plate surface of the insulating plate 32 is bonded to the anode lead portions 1a and the anode lead plate 6 by means of the conductive adhesive 40.

The cathode wiring portion 33b exposed from the second plate surface of the insulating plate 32 is bonded to the cathode layers 3 by means of the conductive adhesive 40.

Moreover, the four capacitor elements 10 to which the terminal plate 30 is connected are housed in a resin case 20.

Next, a method of manufacturing the solid electrolytic capacitor of the first embodiment will be described.

Four sheets of laminated capacitor elements 10 are first manufactured as follows.

Aluminum foil with a thickness of 150 μm was first prepared. This foil is commercially available for aluminum electrolytic capacitor. A porous layer with a thickness of 50 μm is formed on a surface of this foil. Moreover, an oxide film is formed on a surface of the porous layer by chemical conversion treatment with application of voltage of 4V. Therefore, a dielectric layer 2 with a thickness of 50 μm is formed in this foil. Capacitance of this foil per unit area (cm²) is 400 μF.

An anode plate 1 on which the dielectric layer 2 with a width of 2.5 mm and a length of 5.0 mm was formed was cut out using this aluminum foil.

Next, a range of 0.5 mm from one end of the anode plate 1 in the longitudinal direction L1 is set as an anode lead portion 1a. A cathode layer 3 is to be formed in a range of remaining 4.0 mm separated by 0.5 mm from the anode lead portion 1a, as will be described later. An insulator 5 with a thickness of 15 μm was formed in the range of 0.5 mm between the anode lead portion 1a and the range of 4.0 mm by means of screen printing of epoxy resin.

A solid electrolyte layer 3a made of electroconductive polymer was formed in the dielectric layer 2 of the range of 4.0 mm in the anode plate 1. A thickness of the solid electrolyte layer 3a is extremely thin. The electroconductive polymer is one obtained by causing 3,4-ethylenedioxythiophene as a monomer, ammonium peroxodisulfate as an oxidizing agent and p-toluenesulfonate as a dopant to react with a molar ratio of 6:1:2. A graphite layer 3b with a thickness of 15 μm was formed on the solid electrolyte layer 3a by screen printing of graphite. Conductive paste containing silver of a weight ratio of 80% or more was applied onto the graphite layer 3b by a thickness of 30 μm. By leaving the anode plate 1 to which the conductive paste was applied at 150° C., organic solvent in the conductive paste was volatilized to form a metallic layer 3c with a thickness of 25 μm. The cathode layer 3 including the solid electrolyte layer 3a, the graphite layer 3b and the metallic layer 3c was formed as described above.

Next, aluminum was exposed by eliminating the oxide film on the surface of the anode lead portion 1a, and the anode lead plate 6 was bonded to the first plate surface of the anode lead portion 1a by means of welding. The capacitor element 10 to which the anode lead plate 6 is bonded was manufactured as described above.

Next, conductive adhesive 40 was applied to the cathode layer 3 (metallic layer 3c) of the capacitor element 10 by only a thickness of 40 μm, and four sheets of capacitor elements 10 were laminated and bonded.

A terminal plate 30 is also manufactured separately. The terminal plate 30 is manufactured by a method of manufacturing a board having a known three-dimensional wiring structure.

Next, the terminal plate 30 was bonded to the four sheets of laminated capacitor elements 10 so as to face the side surface of capacitor element 10 parallel to the longitudinal direction L1 and the thickness direction t1 of the anode plate 1. Namely, the anode wiring portion 31b exposed from the second plate surface of the insulating plate 32 in the terminal plate 30 was bonded to the anode lead portions 1a and the anode lead plate 6 by means of the conductive adhesive 40.

Further, the cathode wiring portion 33b exposed from the second plate surface of the insulating plate 32 was bonded to the cathode layers 3 by means of the conductive adhesive 40.

Moreover, the four capacitor elements 10 to which the terminal plate 30 is connected were housed in the resin case 20. In this regard, in place of the resin case 20, the four capacitor elements 10 may be molded in.

### Second Embodiment

A solid electrolytic capacitor according to a second embodiment of the present invention differs from one in the first embodiment in view of an anode lead plate For this reason, detailed description for parts equivalent or similar to those in the first embodiment is omitted.

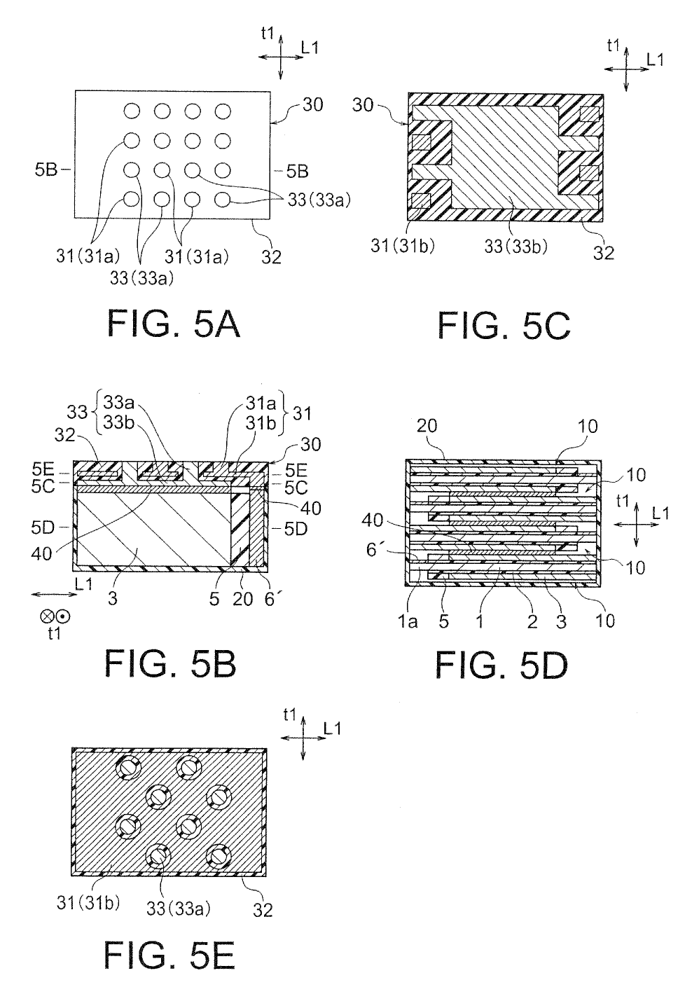

Referring to FIGS. 5A to 5E, a solid electrolytic capacitor according to a second embodiment of the present invention includes a plurality of laminated capacitor elements 10 and a terminal plate 30 attached to the plurality of capacitor elements 10.

Each capacitor element 10 includes an anode plate 1, a dielectric layer 2 and a cathode layer 3, as shown in FIG. 2.

The anode plate 1 is foil made of aluminum as valve action metal, and having a longitudinal direction L1. A surface of the anode plate 1 is made porous by means of etching. The anode plate 1 is provided with an anode lead portion 1a at one end in the longitudinal direction L1.

The dielectric layer 2 is made of an oxide film of aluminum as valve action metal, and is formed on the anode plate 1 except for the anode lead portion 1a.

The cathode layer 3 is formed on the dielectric layer 2, and includes a solid electrolyte layer 3a made of electroconductive polymer.

Namely, in this solid electrolytic capacitor, it is possible to utilize a capacitor element with the same simple structure as that of conventional one.

The second embodiment of the present invention is one capable of further reducing resistance between the anode plate 1 (anode lead portion 1a) and an anode terminal 31.

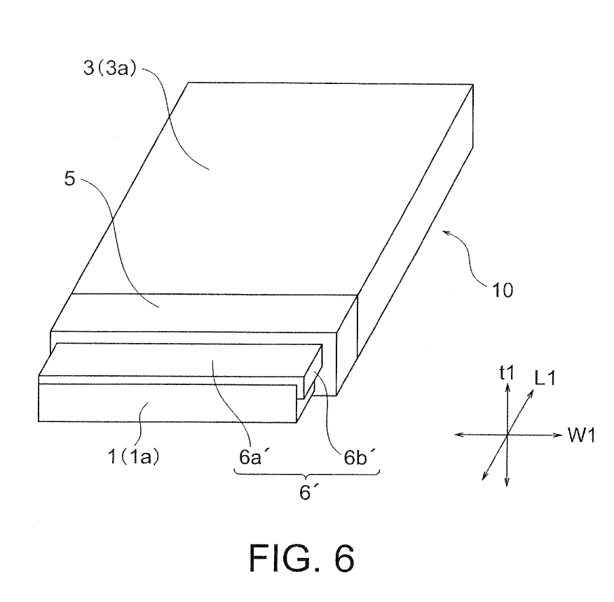

As shown in FIG. 6, an anode lead plate 6′ is connected to the anode lead portion 1a of each capacitor element 10. The anode lead plate 6′ presents an L-shaped form. The anode lead plate 6′ is provided with a first side 6a′ and a second side 6b′. The first side 6a′ is connected to a first plate surface of the anode lead portion 1a by means of welding or the like. The second side 6b′ extends onto a side surface of the anode lead portion 1a, which is bent from the first side 6a′ to face the terminal plate 30. The second side 6b′ may also be connected to the side surface of the anode lead portion 1a by means of welding or the like.

The first side 6a′ of the anode lead plate 6′ is formed across the full width in a width direction W1 of the first plate surface of the anode lead portion 1a. On the other hand, the second side 6b′ of the anode lead plate 6′ is formed in a range of one third to a half of a thickness of the anode lead portion 1a.

Since a contact area with the anode lead portion 1a of the anode lead plate 6′ is wider than the anode lead plate 6 of the first embodiment, the solid electrolytic capacitor of the second embodiment is superior to mechanical strength. In addition, since a connection area to the anode terminal 31 is wider than the anode lead plate 6, parasitic resistance is to be reduced.

Four sheets of capacitor elements 10 to each of which the anode lead plate 6′ is connected are laminated along a thickness direction t1 of the anode plate 1, as shown in FIG. 5D.

The cathode layers 3 of the adjacent capacitor elements 10 are bonded by means of conductive adhesive 40.

Further, the adjacent laminated capacitor elements 10 are arranged so that the anode lead portions 1a are opposed to each other.

In this solid electrolytic capacitor, as well as the first embodiment, the terminal plate 30 is attached to the capacitor elements 10 so that a second plate surface of an insulating plate 32 faces a side surface of each capacitor element 10 parallel to the longitudinal direction L1 and the thickness direction t1 of the anode plate 1. An anode wiring portion 31b exposed from the second plate surface of the insulating plate 32 are then bonded to the anode lead portions 1a and the second side 6b′ of the anode lead plate 6′ by means of the conductive adhesive 40. A cathode wiring portion 33b exposed from the second plate surface of the insulating plate 32 is bonded to the cathode layers 3 by means of the conductive adhesive 40. The four capacitor elements 10 to which the terminal plate 30 is connected are housed in a resin case 20.

The solid electrolytic capacitor according to the second embodiment of the present invention is manufactured in the similar manner to that in the first embodiment except for bonding of the anode lead plate 6′. For this reason, detailed description thereof is omitted.

### Third Embodiment

A solid electrolytic capacitor according to a third embodiment of the present invention differs from one in the first embodiment in view of a plurality of anode terminals and a plurality of cathode terminals of a terminal plate. For this reason, detailed description for parts equivalent or similar to those in the first embodiment is omitted.

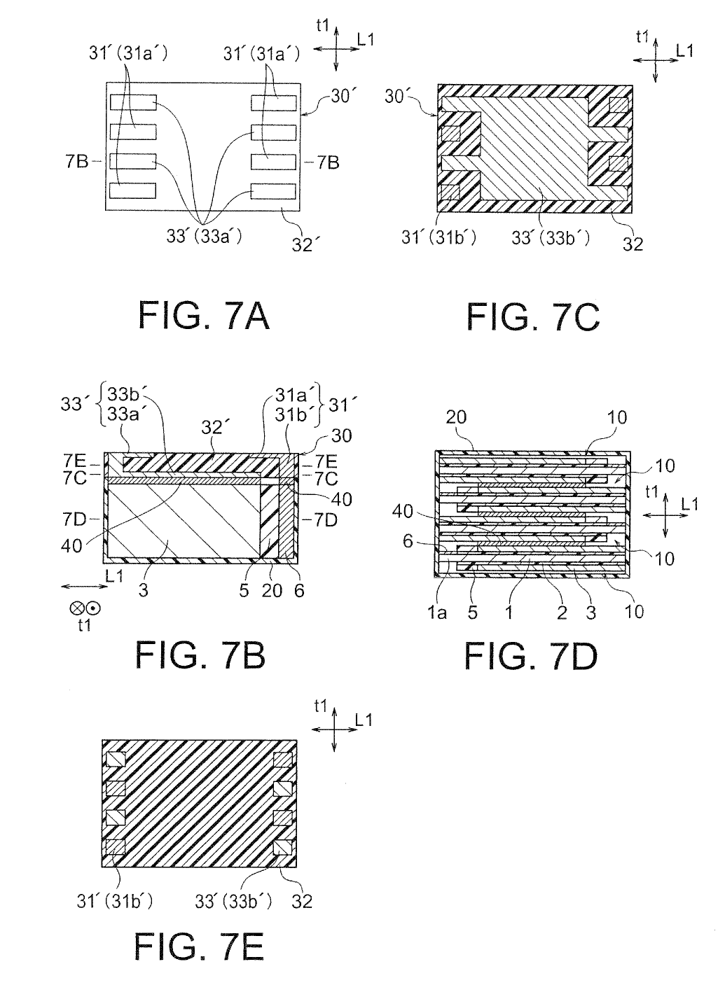

Referring to FIGS. 7A to 7E, a solid electrolytic capacitor according to a third embodiment of the present invention includes a plurality of laminated capacitor elements 10 and a terminal plate 30′ attached to the plurality of capacitor elements 10.

Each capacitor element 10 includes an anode plate 1, a dielectric layer 2 and a cathode layer 3, as shown in FIG. 2.

The anode plate 1 is foil made of aluminum as valve action metal, and having a longitudinal direction L1. A surface of the anode plate 1 is made porous by means of etching. The anode plate 1 is provided with an anode lead portion 1a at one end in the longitudinal direction L1.

The dielectric layer 2 is made of an oxide film of aluminum as valve action metal and is formed on the anode plate 1 except for the anode lead portion 1a.

The cathode layer 3 is formed on the dielectric layer 2, and includes a solid electrolyte layer 3a made of electroconductive polymer.

Namely, in this solid electrolytic capacitor, it is possible to utilize a capacitor element with the same simple structure as that of conventional one.

An anode lead plate 6 is connected to one plate surface of the anode lead portion 1a of each capacitor element 10 by means of welding or the like, as shown in FIG. 4.

The four sheets of capacitor elements 10 to each of which the anode lead plate 6 is connected are then laminated along the thickness direction t1 of the anode plate 1, as shown in FIG. 7D.

The cathode layers 3 of the adjacent capacitor elements 10 are bonded by means of conductive adhesive 40.

Further, the adjacent laminated capacitor elements 10 are arranged so that the anode lead portions 1a are opposed to each other.

The third embodiment of the present invention is one to simplify a structure of the terminal plate.

The terminal plate 30′ includes an insulating plate 32′, a plurality of anode terminals 31′ and a plurality of cathode terminals 33′.

The plurality of anode terminals 31′ include a plurality of anode terminal portions 31a′ and a single anode wiring potion 31b′ connected to these. The plurality of anode terminal portions 31a′ are formed on a first plate surface of the insulating plate 32′ so as to be arranged in two lines at both ends of the first plate surface in the longitudinal directions as shown in FIG. 7A. Moreover, the plurality of anode terminal portions 31a′ are respectively connected in common to the anode lead portions 1a of the capacitor elements 10 via the anode wiring portions 31b′ as shown in FIG. 7B.

In this regard, as is clear from FIG. 7E, the anode wiring portion 31b′ presents a tabular shape.

As is clear from FIGS. 7A and 7B, four anode terminal portions 31a′ with an L-shaped section are formed on a first plate surface of the anode wiring portion 31b′. As is clear from FIGS. 7B and 7E, in the anode wiring portion 31b′, four notches are formed in correspondence to cathode terminal portions 33a′ of the cathode terminal 33′ (will be described later).

On the other hand, as is clear from FIGS. 7A, 7B, 7C, and 7D, four projections are formed on a second plate surface of the anode wiring portion 31b′ in correspondence to the anode lead portions 1a of the four capacitor elements 10. These projections are exposed onto the second plate surface of the insulating plate 32′, and function as terminals to be bonded to the anode lead portions 1a.

The plurality of cathode terminals 33′ include the plurality of cathode terminal portions 33a′ and a single cathode wiring portion 33b′ connected to these. The plurality of cathode terminal portions 33a′ are formed on the first plate surface of the insulating plate 32′ so as to be arranged alternately with the anode terminals 31′, as shown in FIG. 7A. Moreover, the plurality of cathode terminal portions 33a′ are respectively connected in common to the cathode layers 3 of the capacitor elements 10 via the cathode wiring portion 33b′, as shown in FIG. 7B.

In this regard, as is clear from FIGS. 7B and 7C, the cathode wiring portion 33b′ presents a tabular shape.

As is clear from FIGS. 7A and 7B, the four cathode terminal portions 33a′ with an L-shaped section are formed on a first plate surface of the cathode wiring portion 33b′ in correspondence to the four notches of the anode wiring portion 31b′ shown in FIG. 7E. Further, as is clear from FIGS. 7B and 7C, the cathode wiring portion 33b′ presents a plate shape in correspondence to the cathode layers 3 of the four capacitor elements 10.

A second plate surface of the cathode wiring portion 33b′ is exposed onto the second plate surface of the insulating plate 32′, and functions as a terminal to be bonded to the cathode layers 3.

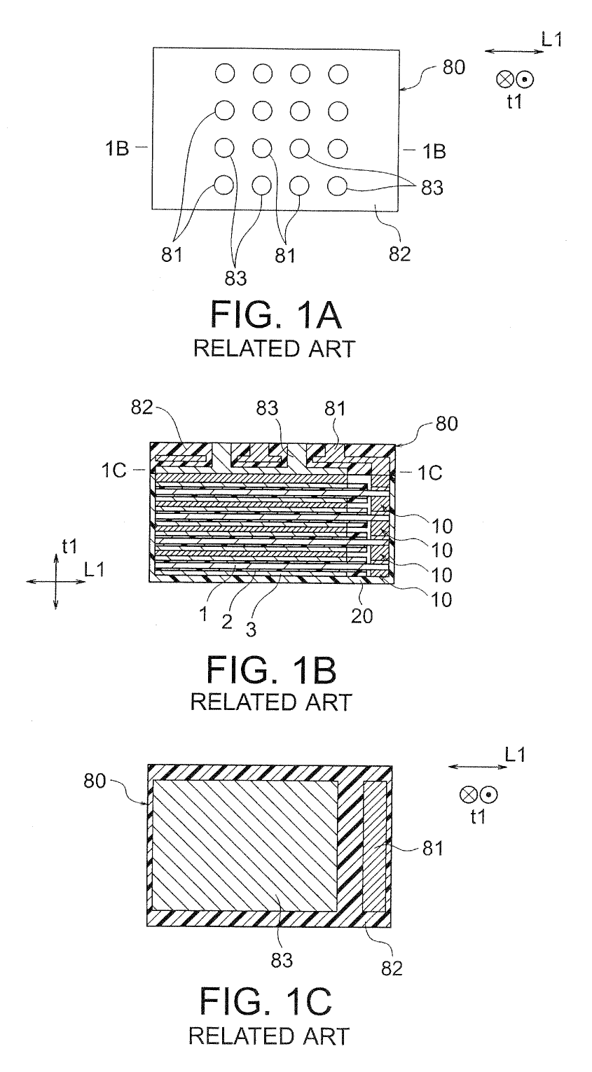

In the solid electrolytic capacitor of the third embodiment, the structure of the anode terminal 31′ and the cathode terminal 33′ of the terminal plate 30′ is simpler than that in the conventional solid electrolytic capacitor shown in FIGS. 1A to 1D.

In this solid electrolytic capacitor, as well as the first embodiment, the terminal plate 30′ is attached to the capacitor elements 10 so that the second plate surface of the insulating plate 32′ faces a side surface of each capacitor element 10 parallel to the longitudinal direction L1 and the thickness direction t1 of the anode plate 1.

The anode wiring portion 31b′ exposed from the second plate surface of the insulating plate 32′ is then bonded to the anode lead portions 1a and the anode lead plate 6 by means of the conductive adhesive 40.

The cathode wiring portion 33b′ exposed from the second plate surface of the insulating plate 32′ is bonded to the cathode layers 3 by means of the conductive adhesive 40.

The four capacitor elements 10 to which the terminal plate 30 is connected are housed in a resin case 20.

The solid electrolytic capacitor according to the third embodiment of the present invention is manufactured in the similar manner to that in the first embodiment except for manufacturing of the terminal plate 30′. The terminal plate 30′ is manufactured by a method of manufacturing a board having a known three-dimensional wiring structure as well as the terminal plate 30 of the first embodiment. For this reason, detailed description thereof is omitted. In this regard, since a structure of the terminal plate 30′ is simple, the number of steps in the third embodiment may be fewer than that in the first embodiment.

Measurement of Electrical Characteristic

Electrical characteristics of the solid electrolytic capacitor according to the present invention were measured.

Solid electrolytic capacitors according to the first to third embodiments of the present invention were manufactured as samples.

In addition, a conventional solid electrolytic capacitor shown in FIGS. 1A to 1D was also manufactured as a comparative embodiment. In this regard, the solid electrolytic capacitor of the comparative embodiment was also manufactured using the same capacitor element 10 as that in the first to third embodiments.

30 pieces of solid electrolytic capacitors for each type were manufactured.

Measurement items are capacitance, ESR, ESL and leakage current.

Both the capacitance and the ESR were measured by an AC impedance bridge method.

The capacitance was measured by applying a reference signal of DC bias of 0V, frequency of 120 Hz and voltage of 1 Vrms thereto.

Further, the ESR was measured by applying a reference signal of DC bias of 0V, frequency of 100 kHz and voltage of 1 Vrms thereto.

The ESL was measured as follows. Namely, the solid electrolytic capacitor was bonded to an evaluation board by means of soldering. An S21 characteristic (transfer characteristic) at 100 MHz of the solid electrolytic capacitor was measured using a network analyzer. The ESL was then calculated by simulation of an equivalent circuit on the basis of the measured S21 characteristic.

Further, the leakage current was measured at one minute after starting to apply a signal with rated voltage of 2.5V to the solid electrolytic capacitor.

The respective characteristics of the first to third embodiments and the comparative embodiment are shown in Table. Each characteristic is an average value of the 30 pieces of solid electrolytic capacitors.

| | Capacitance | ESR | ESL | Leakage Current |
|---|---|---|---|---|
| First | 130 μF | 3.8 mΩ | 120 pH | 12 μA |
| Embodiment | | | | |
| Second | 131 μF | 3.5 mΩ | 122 pH | 11 μA |
| Embodiment | | | | |
| Third | 131 μF | 3.9 mΩ | 145 pH | 11 μA |
| Embodiment | | | | |
| Comparative | 130 μF | 3.9 mΩ | 320 pH | 10 μA |
| Embodiment | | | | |

As is seen from Table, in each of the first to third embodiments, the ESL is 150 pH or less, and the ESL is greatly lower than that in the comparative embodiment.

Further, the value of the ESR in the second embodiment is somewhat smaller than that in the first embodiment. This is because resistance between the anode lead portion and the anode terminal is low.

Further, in the third embodiment, a structure of the terminal plate is also simple and the terminal plate is low cost, but the ESL is sufficiently lower than that in the comparative embodiment.

The present invention is not limited to some embodiments described above. It is needless to say that various modifications can be applied to the present invention so long as such modifications are within a technical scope of claims.

What is claimed is:

1. A solid electrolytic capacitor comprising a plurality of capacitor elements laminated to one another and a terminal plate attached to the plurality of capacitor elements;
wherein each of the plurality of capacitor elements includes an anode plate, a dielectric layer, and a cathode layer, the anode plate being made of valve action metal and having a longitudinal direction, the anode plate being provided with an anode lead portion at one end of the longitudinal direction, the dielectric layer being made of an oxide film of valve action metal, the dielectric layer being formed on the anode plate except for the anode lead portion, the cathode layer including a solid electrolyte layer made of electroconductive polymer, the cathode layer being formed on the dielectric layer;
wherein the plurality of capacitor elements are further laminated along a thickness direction of the anode plate;
wherein the terminal plate includes an insulating plate, a plurality of anode terminals, and a plurality of cathode terminals, the plurality of anode terminals being formed on a first plate surface of the insulating plate, the plurality of anode terminals being respectively connected in common to the anode lead portions of the capacitor elements, the plurality of cathode terminals being formed on the first plate surface of the insulating plate so as to be arranged alternately with the anode terminals, the plurality of cathode terminals being respectively connected in common to the cathode layers of the capacitor elements; and
wherein the terminal plate is further attached to the capacitor elements so that a second plate surface of the insulating plate faces a side surface of each of the capacitor elements, the side surface being parallel to the longitudinal direction and the thickness direction of the anode plate.

2. The solid electrolytic capacitor according to claim 1, wherein the capacitor elements laminated so as to be adjacent are arranged so that the anode lead portions thereof face each other.

3. The solid electrolytic capacitor according to claim 1, wherein the plurality of anode terminals are formed on the first plate surface of the insulating plate so as to be arranged in a matrix manner.

4. The solid electrolytic capacitor according to claim 1, wherein the anode lead portion is connected to the anode terminal via an anode lead plate connected to its plate surface.

5. The solid electrolytic capacitor according to claim 4, wherein the anode lead plate presents an L-shaped form, and the anode lead plate is provided with a first side connected to the plate surface of the anode lead portion and a second side extending onto a side surface of the anode lead portion that is bent from the first side to face the terminal plate.

6. The solid electrolytic capacitor according to claim 1, wherein the anode terminals and the cathode terminals are respectively bonded to the anode lead portions and the cathode layers by means of conductive adhesive.

7. An electronic apparatus comprising the solid electrolytic capacitor according to claim 1 and a semiconductor device electrically connected to the solid electrolytic capacitor.
